(19) United States
(12) Patent Application Publication
(10) Pub. No.: US 2020/0350105 A1
(43) Pub. Date: Nov. 5, 2020

(54) Common-Mode Current Suppression Device Utilizing A Nanocrystalline Core(s)

(71) Applicant: PDS Electronics, Inc., Tallmadge, OH (US)

(72) Inventor: Paul D. Sergi, Peninsula, OH (US)

(73) Assignee: PDS Electronics, Inc., Tallmadge, OH (US)

(21) Appl. No.: 16/862,880

(22) Filed: Apr. 30, 2020

Related U.S. Application Data
(60) Provisional application No. 62/841,117, filed on Apr. 30, 2019.

(51) Int. Cl. H01F 1/147; H01F 17/06; H01F 27/28

(52) U.S. Cl. CPC H01F 1/14766; H01F 2017/0093; H01F 27/2823; H01F 17/06

(57) ABSTRACT

A common-mode current suppression device, such as a balun and line isolator, includes a core formed of nanocrystalline material. The core may be formed in any desired configuration, such as a toroidal core, a sleeve core, a drum core, a rod core, or a binocular core. The use of nanocrystalline material allows the core to achieve increased common-mode impedance (CMI) that exceeds that achievable by cores formed of traditional ferromagnetic materials.

### CROSS-REFERENCE TO RELATED APPLICATION

This application claims the benefit of U.S. Provisional Patent Application No. 62/841,117 filed on Apr. 30, 2019, the contents of which are incorporated herein by reference.

### TECHNICAL FIELD

The various embodiments disclosed herein relate to common-mode current suppression devices. In particular, the various embodiments disclosed herein relate to common-mode current suppression devices, such as baluns and line isolators having one or more cores formed of nanocrystalline material.

### BACKGROUND

Providing common-mode current suppression devices, hereinafter referred to as CMDs, such as baluns and line isolators, which have increased levels of common-mode impedance (CMI) is highly advantageous. Such devices are highly sought after by consumers, such as those who participate in the field of HAM (i.e. amateur) radio, as well as the military and commercial industry. Currently, manufacturers increase the CMI of their CMD devices by utilizing a core with increased magnetic permeability; or by stacking multiple cores together to form a “stacked core”, whereupon multiple turns of coaxial cable, or parallel wires are wound through the entire stack. However, such techniques are still limited in the amount of increased CMI that can be achieved.

Therefore, it would be desirable to provide a common-mode current suppression device (CMD) utilizing a core material that enables further increases in CMI over currently available CMDs.

### SUMMARY

It is one aspect of the various embodiments disclosed herein to provide a core for a current suppression device that includes a core formed of nanocrystalline material.

It is another aspect of the various embodiments disclosed herein to provide a current suppression device that includes a core formed of nanocrystalline material, and a conductive wire that is at least partially wound relative to at least a portion of the core.

It is yet another aspect of the various embodiments disclosed herein to provide the nanocrystalline core, wherein the nanocrystalline material utilized includes FeCuNbSiB.

It is still another aspect of the various embodiments disclosed herein to provide the nanocrystalline core, wherein the nanocrystalline material utilized includes Fe_{73.5}Cu₁Nb₃Si_{15.5}B₇.

### BRIEF DESCRIPTION OF THE DRAWINGS

The various embodiments disclosed herein will become better understood with regard to the following description, accompanying drawings and claims wherein:

FIG. 1 is a perspective view of a common-mode current suppression device (CMD) having a stacked nanocrystalline toroidal core in accordance with the concepts of the various embodiments disclosed herein;

FIG. 2 is a graph showing the common-mode impedance vs. frequency of a CMD configured as a balun having a single core formed of conventional ferrite material and a balun having a single core formed of nanocrystalline material in accordance with the concepts of the various embodiments disclosed herein;

FIG. 3 is a graph showing the common-mode impedance vs. frequency performance of a CMD configured as a balun having a stacked toroidal core with 7 turns of coaxial cable, and a balun having a stacked toroidal core with 11 turns of coaxial cable, with each of the cores being formed of nanocrystalline material in accordance with the concepts of the various embodiments disclosed herein; and

FIG. 4 is a graph showing the frequency vs. common-mode impedance performance of a CMD configured as a balun having a stacked core of two axially-aligned toroid cores formed of a composition of manganese and zinc (MnZn ferrite), which is offered under the tradename “31 Material” that is sold by Fair-Rite Products Corp, and which includes 11 wraps/turns of RG-303 coaxial cable denoted as COM-LI11140-312); a CMD configured as a balun having a stacked core of two axially-aligned toroid cores formed of nanocrystalline material (Fe_{73.5}Cu₁Nb₃Si_{15.5}B₇) with either 7 wraps/turns of RG303 coaxial cable (denoted as 7 Wrap 303 Coax W1JR); 8 wraps/turns of RG303 coaxial cable (denoted as 8 Wrap 303 Coax W1JR), or 9 wraps turns of RG303 coaxial cable (denoted as 9 Wrap 303 Coax W1JR), whereby all cores are wrapped using the Reisert method in accordance with the concepts of the various embodiments disclosed herein.

### DETAILED DESCRIPTION

A common-mode current suppression device (CMD), such as a balun or line isolator for example, which utilizes one or more cores of nanocrystalline material, is disclosed herein. In some embodiments, the nanocrystalline material comprises the chemical compound FeCuNbSiB, where Fe is iron; Cu is copper; Nb is niobium; Si is silicon; and B is boron. It should be appreciated that in further embodiments, the nanocrystalline material may comprise the chemical compound Fe_{73.5}Cu₁Nb₃Si_{15.5}B₇, and the like.

In some embodiments, the one or more cores utilized by the CMD may comprise a toroidal core, a sleeve core, a drum core, a rod core, a double aperture (binocular) core, and the like.

Still, in further embodiments, when multiple cores are utilized, they may be arranged in a “stacked” arrangement. That is, the CMD may utilize a plurality of cores that are placed adjacent to each other, such as to be in electrical and/or magnetic communication with each other. In other embodiments, the multiple cores are separately coupled together in series by a length of a conductive wire, such as a coaxial cable. In some embodiments, the plurality of stacked cores may be arranged so that they are separated by one or more layers of other material. For example, the stacked cores may be joined together by an adhesive layer or other suitable attachment means.

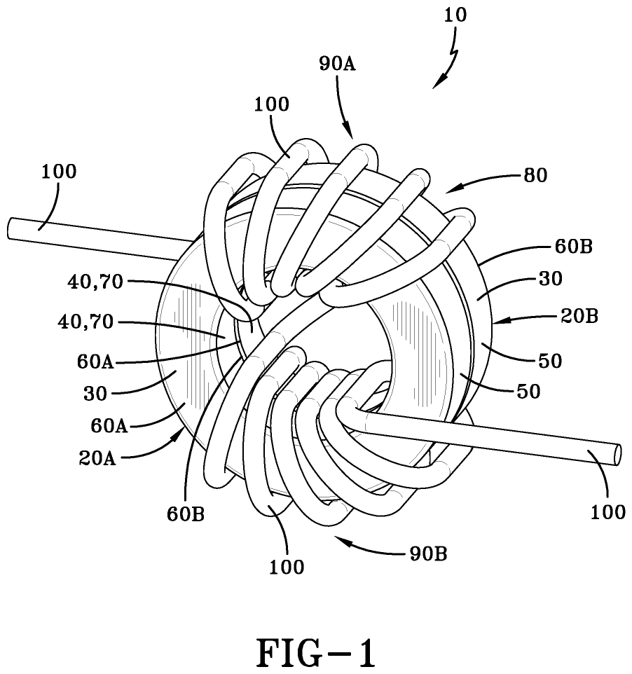

The various CMD cores disclosed herein may be utilized with an electrically conductive wire, such as a coaxial cable, or other single or multiple conductor wire, which may be shielded or unshielded. This conductive wire is wrapped through, around, about or relative to one or more different portions of a single nanocrystalline core or multiple nanocrystalline cores to form one or more partial or complete wraps/turns/windings as desired. In the embodiments where the core includes apertures therethrough, the conductive wire may be wrapped through this aperture to form one or more partial or complete wraps/turns/windings, such as that shown in FIG. 1 to be discussed. In some embodiments, the coaxial cable may comprise RG303 (i.e. Radio Guide-303) Teflon dielectric coaxial cable for example, however other variations of RG coaxial cable may be utilized, including but not limited to RG400 and RG142 for example.

In one embodiment, a multi-core CMD 10 is shown in FIG. 1, which utilizes cores 20A and 20B formed of the nanocrystalline material. The cores 20A-B are toroidal in shape. As such, each of the toroidal cores 20A-B has a body 30 that is defined by a cylindrical inner surface 40 and a cylindrical outer surface 50, which are spaced apart by opposed annular lateral surfaces 60A-B. The cylindrical inner surface 40 defines an annular opening 70 that extends through the body 30. The cores 20A-B are positioned adjacent to each other, such that each of their annular openings 70 are coaxially aligned with each other, so as to form a core “stack” 80.

The cores 20A-B are formed of nanocrystalline material. In some embodiments, the nanocrystalline material may have the chemical compound FeCuNbSiB. Alternatively, the nanocrystalline material may have the chemical compound Fe_{73.5}Cu₁Nb₃Si_{15.5}B₇. In addition, a coaxial cable 100 is wrapped around the stacked cores 20A-B. In some embodiments, the coaxial cable 100 includes a central conductor that is separated from a conductive outer layer by an inner dielectric material, while the conductive outer layer is covered by an outer dielectric material to shield it from the external environment. The coaxial cable 100 is wound through the openings 70 and over the cylindrical outer surfaces 50 of the stack 80 of cores 20A-B, so as to form one or more turns or windings of the coaxial cable 100. In some embodiments, the wraps/turns may be spaced uniformly relative to the stack 80 or may be arranged so that a first group 90A of turns is positioned substantially opposite to a second group 90B of turns, as shown in FIG. 1. In other embodiments, the windings may not wrap completely around the core or portion of the core. In one embodiment, the first 90A and second group 90B of turns may have an equal or unequal number of turns relative to one another. For example, in the embodiment shown in FIG. 1, the first group 90A of turns may include 5 turns 80, while the second group 90B of turns includes 6 turns, for a total of 11 turns. It should be appreciated, however that the CMD 10 may utilize any suitable number of wraps/turns of coaxial cable 100.

### A. Experimental Section:

### 1. Equipment and Test Setup:

The experimentally verified operating performance of various CMDs configured as baluns using one or more toroid cores formed of nanocrystalline material Fe_{73.5}Cu₁Nb₃Si_{15.5}B₇ is presented as follows. A Keysight brand (formerly Agilent & Hewlett-Packard) impedance analyzer having model # E4990-120 was utilized for testing. This impedance analyzer was a 120 MHz version having a high stability time base. It was a new machine purchased from Keysight in 2018 and was calibrated by them before shipment, and the calibration was still current as of the time of the subject experimental test.

The Keysight impedance analyzer was used with an impedance test fixture compatible for use with lead-type devices, this test fixture is offered for sale under the Keysight brand having model #16047E.

In addition, a 1-meter port extension cable offered under the Keysight brand having model #16048G was also used.

The 16048G extension cable extended the 4-terminal pair configuration of the measurement ports of the impedance analyzer for attachment to the 16047E test fixture. The text fixture was coupled to the extension cable using a BNC male connector board. Such a test configuration allows a Device-Under-Test (DUT), such as balun 10, to be located away from any external electrical/magnetic influences that may be caused or induced by the impedance analyzer itself. After the 16047E test fixture was setup, and before any measurements were performed, a standard open-short-load calibration of the test fixture was conducted via the E4990-120 analyzer.

The impedance analyzer was kept in a temperature, humidity and dust controlled environment, and was mounted on an all plastic cart to remove any magnetic effects that could affect the readings if the impedance analyzer were mounted on a metal cart.

The impedance analyzer was supplied with electrical power through a high-quality UPS (uninterruptible power supply). The UPS cleans and stabilizes the power supplied to the impedance analyzer, as well as prevents the power supplied thereto from dropping, especially during the taking of test measurements.

In addition, CATS control cables and power cables utilized by the impedance analyzer were isolated from the external environment using high impedance chokes on the control cables and the power cables.

### 2. Measurements:

As a further step in isolating the impedance analyzer from external electrical/magnetic influences when taking readings, the impedance analyzer was always controlled from a distance of at least 4 feet from the Device-Under-Test (DUT) by using Internet Explorer through a USB (universal serial bus) port shown above. This web server is built into the impedance analyzer, allowing functions performed on the impedance analyzer itself to be performed remotely through this interface.

a. Single-Core/Single-Turn Balun:

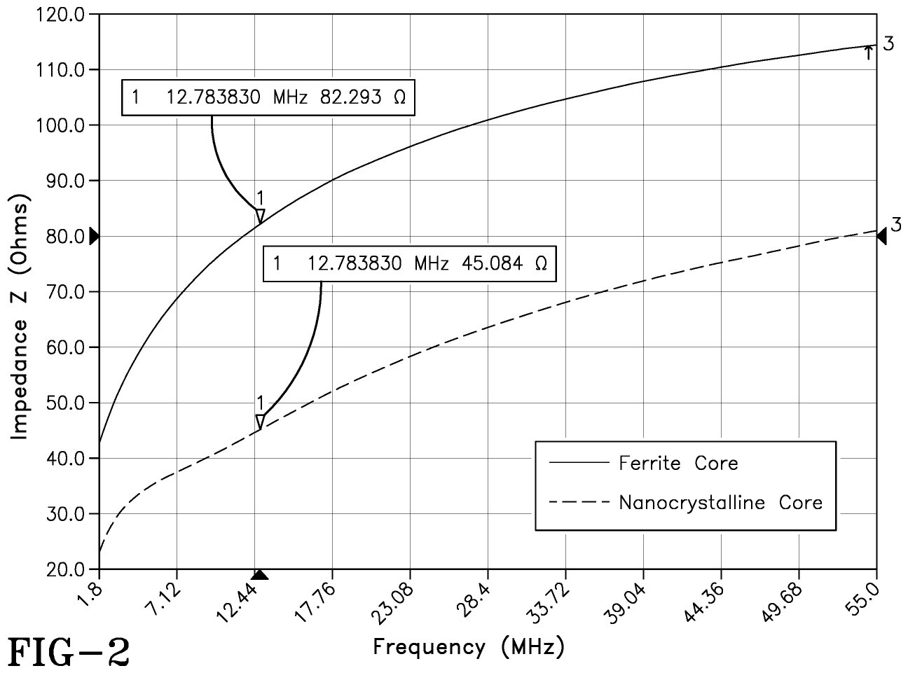

For testing purposes, a measurement test set-up was used for evaluating a CMD having a single toroidal ferrite core and a CMD configured with a single toroidal nanocrystalline core utilizes the 160474E test fixture along with a just-long-enough piece of 14-gauge stranded wire to form the single-turn, whereby the single turn of wire was electrically coupled to the impedance analyzer via the 16047E test fixture. Continuing, FIG. 2 shows a graph of the common-mode impedance Z taken during the single-turn measurement using the ferrite core formed of 31 Material (a composition of manganese and zinc (MnZn ferrite) that is sold by Fair-Rite Products Corp) and using the nanocrystalline core having the composition of Fe_{73.5}Cu₁Nb₃Si_{15.5}B₇ using the impedance analyzer, as viewed on a web browser (Internet Explorer brand), which was utilized to control the impedance analyzer. The pair of markers #1, shown in FIG. 2, identify that the value of the common-mode impedance at 12.78 MHz was 82.2 Ohms for the single-turn nanocrystalline core, and was 45.08 Ohms for the single-turn ferrite core. Thus, the common-mode impedance performance achieved by the single nanocrystalline core clearly exceeds that of the ferrite core.

b. Multi-Core/Multi-Turn Balun:

A measurement test set up of a double stack (as shown in FIG. 1) of nanocrystalline toroid cores was pursued. The toroid cores had the composition of Fe_{73.5}Cu₁Nb₃Si_{15.5}B₇, utilizing 11 wraps/turns (as well as 7 wraps/turns) of RG303 Teflon dielectric coaxial cable electrically coupled to a custom fixture that was used to electrically interface the baluns to the impedance analyzer. This custom fixture was suggested and approved by Mark Robinson, PhD EE, Keysight Microwave Applications Engineer, for measuring items whose physical width exceeds the width of the 16047E measurement fixture.

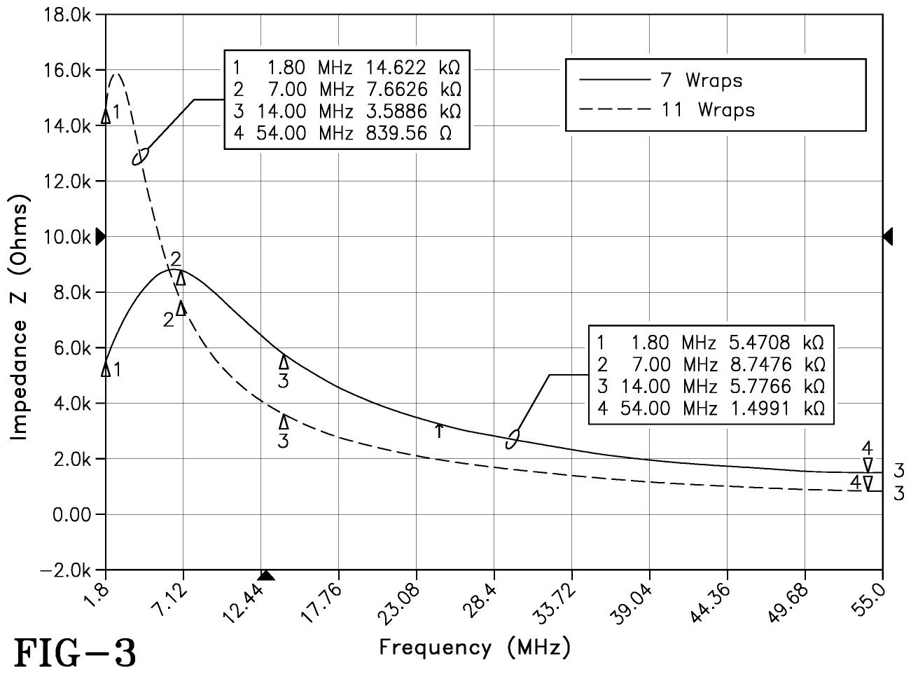

FIG. 3 shows a graph of the measured common-mode impedance performance of each of the baluns, one having 11 wraps/turns and the other having 7 wraps/turns. The experimental results show that when the balun having 7 wraps/turns of coaxial cable is used, the impedance peak is not as high as it is with a balun having 11 wraps/turns of coaxial cable. However, due to the high magnetic permeability of the nanocrystalline core, the peak impedance of the 7 wrap/turn core is still quite high and is much wider. In addition, the impedance achieved by the 7 wrap/turn core at higher frequencies is higher than that achieved with the 11 wrap/turn core. For instance, at a frequency of 54 MHz, the impedance achieved by the 7 wrap/turn core is substantially above 1000 Ohms, which is an accepted standard of minimum performance, whereas the 11 wrap/turn core is only 839 Ohms. Thus, the results presented herein exemplify a desirable and unpredicted characteristic of the nanocrystalline material when used as a balun core. That is, the nanocrystalline core(s) achieve as much impedance as a ferrite core(s), but with fewer wraps/turns of coaxial cable. Or conversely, a nanocrystalline core(s) achieves greater impedance as compared to a ferrite core(s) when using the same number of wraps/turns.

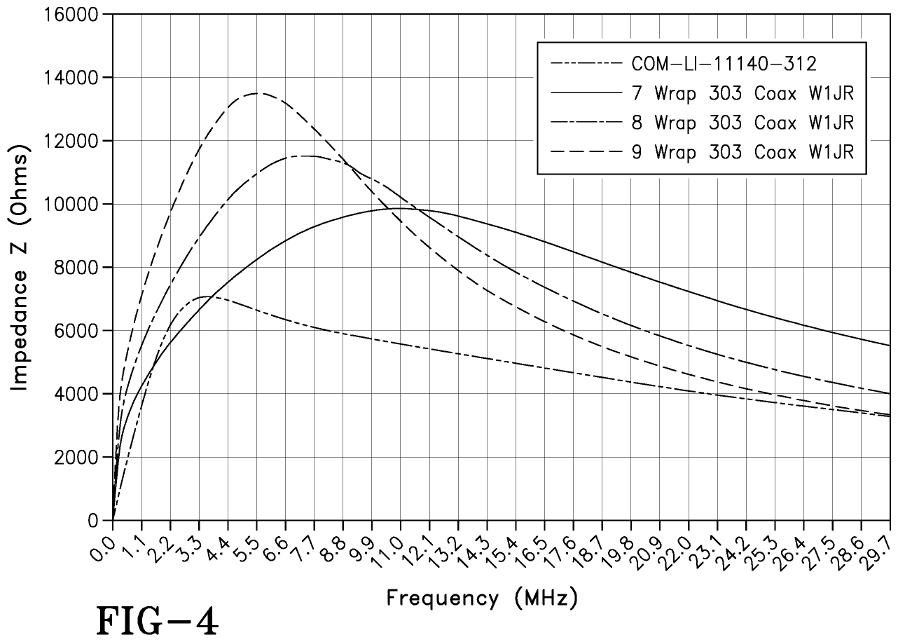

FIG. 4 shows the frequency vs. common-mode impedance performance of a balun having a stacked core of two axially-aligned toroid cores formed of a composition of manganese and zinc (MnZn ferrite), which is offered under the tradename “31 Material” that is sold by Fair-Rite Products Corp, and which includes 11 wraps/turns of RG-303 coaxial cable denoted as COM-LI11140-312) using the Reisert method. In addition, FIG. 4 also shows the frequency vs. common-mode impedance performance of a balun having a stacked core of two axially-aligned toroid cores formed of nanocrystalline material (Fe_{73.5}Cu₁Nb₃Si_{15.5}B₇) with either 7 wraps/turns of RG303 coaxial cable (denoted as 7 Wrap 303 Coax W1JR); 8 wraps/turns of RG303 coaxial cable (denoted as 8 Wrap 303 Coax W1JR), or 9 wraps turns of RG303 coaxial cable (denoted as 9 Wrap 303 Coax W1JR), whereby all cores are wrapped using the Reisert method. As such, the balun utilizing the nanocrystalline core having 8 wraps/turns achieves a higher impedance than the balun that is formed of conventional “31 Material” and provides an impedance that is much greater at higher frequencies than the nanocrystalline core that utilizes 9 wraps/turns.

Therefore, it can be seen that the objects of the various embodiments disclosed herein have been satisfied by the structure and its method for use presented above. While in accordance with the Patent Statutes, only the best mode and preferred embodiments have been presented and described in detail, with it being understood that the embodiments disclosed herein are not limited thereto or thereby. Accordingly, for an appreciation of the true scope and breadth of the embodiments, reference should be made to the following claims.

What is claimed is:

1. A core for a current suppression device comprising a core formed of nanocrystalline material.

2. The core of claim 1, wherein said nanocrystalline material comprises FeCuNbSiB.

3. The core of claim 1, wherein said nanocrystalline material comprises Fe_{73.5}Cu₁Nb₃Si_{15.5}B₇.

4. The core of claim 1, wherein said core comprises a toroidal core, a sleeve core, a drum core, a rod core, or a binocular core.

5. The core of claim 1, wherein said core comprises a plurality of adjacent cores.

6. The core of claim 5, wherein said cores are stacked.

7. A current suppression device comprising:
a core formed of nanocrystalline material; and
a conductive wire at least partially wound relative to at least a portion of said core.

8. The device of claim 7, wherein said nanocrystalline material comprises FeCuNbSiB.

9. The device of claim 7, wherein said nanocrystalline material comprises Fe_{73.5}Cu₁Nb₃Si_{15.5}B₇.

10. The device of claim 7, wherein said conductive wire comprises a coaxial cable.

11. The device of claim 10, wherein said conductive wire forms at least one complete winding.

12. The device of claim 7, wherein said conductive wire is wound around an aperture of said core.

13. The device of claim 7, wherein said core comprises a toroidal core, a sleeve core, a drum core, a rod core, or a binocular core.

14. The device of claim 7, wherein said core comprises a plurality of cores, and said conductive wire is at least partially wound relative to at least a portion of each said core.

15. The device of claim 14, wherein said conductive wire passes through an aperture of said cores.

16. The device of claim 15, wherein said conductive wire forms at least one complete winding relative to each said core.

17. The device of claim 16, wherein said cores are stacked.

18. The device of claim 16, wherein said conductive wire comprises a coaxial cable.

19. The device of claim 15, wherein said cores are spaced apart by a length of said conductive wire.

20. The device of claim 18, wherein said conductive wire comprises a coaxial cable.
